(19) United States
(12) Patent Application Publication
(10) Pub. No.: US 2013/0032281 A1
(43) Pub. Date: Feb. 7, 2013

(54) TRANSFER COATING FOR TEMPORARY PROTECTION

(71) Applicants: Keimpe Jan Van Den Berg, Hudson, OH (US); Dominique Fort, Den Haag (NL); Mark Johannes Maria Van Ginneken, Leiderdorp (NL); Petrus Leonardus Van Der Put, Noordwijk (NL)

(72) Inventors: Keimpe Jan Van Den Berg, Hudson, OH (US); Dominique Fort, Den Haag (NL); Mark Johannes Maria Van Ginneken, Leiderdorp (NL); Petrus Leonardus Van Der Put, Noordwijk (NL)

(73) Assignee: AKZO NOBEL COATINGS INTERNATIONAL B.V., Arnhem (NL)

(21) Appl. No.: 13/577,737

(22) PCT Filed: Feb. 14, 2011
(86) PCT No.: PCT/EP2011/052084

§ 371 Date: Oct. 24, 2012

Related U.S. Application Data
(60) Provisional application No. 61/305,382, filed on Feb. 17, 2010.

(30) Foreign Application Priority Data
Feb. 17, 2010 (EP) 10153859.3

(51) Int. Cl. B32B 27/06; B32B 38/10

(52) U.S. Cl. 156/246; 428/411.1; 156/247

(57) ABSTRACT

The invention relates to a process of applying a temporary protective coating to a substrate comprising the steps of: a) providing a laminate comprising i) a flexible carrier substrate and ii) a coating layer prepared by applying by spreading, spraying or flow coating an aqueous coating composition comprising at least one water based film-forming polymer and solid particles of an amino resin based polymer to the flexible carrier substrate, and drying the applied coating composition, and b) transferring the coating from the flexible carrier substrate to a second substrate to provide the second substrate with a temporary protective coating.

The invention relates to a process of applying a temporary protective coating to a substrate by transfer coating and to a laminate suitable for the process.

EP 0707053 B describes a paint film-protective sheet which can adhere well and can easily be peeled off after adhering for a long period of time. The sheet is suitable for the surface protection of automobile bodies and parts. The known sheet requires an adhesive to achieve sufficient adhesion of the protective layer to the substrate. A disadvantage of this technology is that adhesives or components thereof can penetrate into the substrate to be temporarily protected, such as an automobile coating layer during transport of the automobile from the factory to the dealer. Such penetration can cause the appearance and durability to deteriorate and is therefore undesirable.

International patent application WO 2008/148763 describes an aqueous coating composition for forming a peelable temporary coating on a substrate. The coating composition comprises a water based film-forming polymer and solid particles of an amino resin based polymer. The composition described in this document is very suitable for forming a peelable temporary coating on a substrate. However, the application of wet paint takes time, also for drying of the wet paint. In addition, the application of wet paint by spraying or roller is prone to contamination of the working area with droplets of paint.

The present invention seeks to provide a process for application of a peelable temporary coating on a substrate which does not require the handling of wet paint at the location where the peelable temporary coating is applied to the substrate. In a further aspect, the invention seeks to provide temporary protection of a substrate which does not require an adhesive layer between the substrate and the temporary protective layer.

The invention now provides a process of applying a temporary protective coating to a substrate comprising the steps of:
a) providing a laminate comprising
   i) a flexible carrier substrate and
   ii) a coating layer prepared by applying by spreading, spraying or flow coating an aqueous coating composition comprising at least one water based film-forming polymer and solid particles of an amino resin based polymer to the flexible carrier substrate, and drying the applied coating composition, and
b) transferring the coating from the flexible carrier substrate to a second substrate to provide the second substrate with a temporary protective coating.

The process according to the invention does not require the handling of wet paint at the location where the peelable temporary coating is applied to the substrate. Furthermore, it does not require an adhesive layer between the substrate and the temporary protective layer.

The laminate provided in step a) can suitably be prepared by applying an aqueous coating composition to a flexible carrier substrate and subjecting the applied coating to a drying phase.

The flexible carrier substrate suitably is a film or foil. Examples are aluminium foil or an aluminized layer, for instance an aluminized polyester film, plastic or paper.

In a preferred embodiment, the flexible carrier comprises or essentially consists of a polymeric material, for example polyvinyl chloride, acetate, polyethylene, polyester, an acrylic polymer, polyethylene naphthalate, polyethylene terephthalate or polycarbonate. Examples of other suitable materials are polyvinylalcohol, natural or modified starch, polyalkylene oxide, e.g. polyethylene oxide or polymers modified therewith, polymers and copolymers of (meth)acrylic amide or meth(acrylic) acid. Also mixtures, hybrids, and blends of these materials can be used. The flexible carrier substrate may consist of a single layer. Alternatively, it may be multilayered in itself. Suitably, the surface of the flexible carrier substrate to which the coating composition is applied has a low surface tension. In one embodiment, that surface is a siliconized surface.

As mentioned above, the coating composition comprises a film-forming polymer. The selection of water based film-forming polymers determines, at least in part, the ease of removal of the temporary coating by peeling. Generally, film-forming polymers having a low glass transition temperature (Tg) are preferred. Suitable film-forming polymers may have a Tg of 19° C. or below, or 13° C. or below, or 9° C. or below. Generally, the film-forming polymers will have a Tg of −30° C. or higher, or −25° C. or higher.

The flexibility of the temporary coating likewise has a favourable effect on its peelability. For that reason preferably use is made of a coating composition giving a coat of paint which after drying has a modulus of elasticity of 80 MPa or less, or 50 MPa or less. Good results are also obtained when the modulus of elasticity of the coat of paint is at most 20 MPa. Generally, the modulus of elasticity of the coat of paint is at least 9 MPa, or at least 10 MPa. The elongation at break of the temporary coating is likewise relevant for good peelability. Generally, the elongation at break of the temporary coating is at least 400%, or at least 500%, or even at least 600%, so as to prevent premature breaking of the coating as it is peeled from the substrate. A too high elongation at break is not favourable for peelability. The elongation at break suitably does not exceed 1,000%, preferably it does not exceed 900%. So far very good results have been achieved when the modulus of elasticity is in the range of 5 to 12 MPa, with an elongation at break in the range of 500% to 800%.

Examples of suitable water based film-forming polymers are polyurethanes, polyesters, polycarbonates, and polymers prepared by polymerization of olefinically unsaturated monomers, such as poly(meth)acrylates or copolymers of vinyl acetate. It is also possible to use mixtures and/or hybrids of these types of film-forming polymers.

Suitable water based film-forming polymers are available commercially, such as Revacryl® 274, an aqueous dispersion of an acrylic ester-acrylonitrile copolymer ex Synthomer, Emultex® AC 430, an aqueous dispersion of a vinyl acetate-butyl acrylate copolymer ex Synthomer, Plextol® B 500, an aqueous dispersion of a methacrylic ester-acrylic ester copolymer ex Polymer Latex, or NeoRez® R987, an aqueous polyurethane dispersion ex DSM Neoresins.

The solid particles of an amino resin based polymer are generally present in the coating composition in an amount of at least 1, or at least 2, or even at least 4% by weight, calculated on the total weight of the composition. The upper limit of the amount of the particles suitably is 25%, or 20%, or 14% by weight, calculated on the total weight of the composition. The average particle size generally is in the range of 1 μm to 150 μm. The particles used generally have a particle size distribution. For example, 90% of all particles may be smaller than 14 μm, and 50% of all particles may be smaller 6.5 μm.

In one embodiment, the lateral dimension and the longitudinal dimension of the particles may be of a similar order. The particles may for example be essentially of spherical shape. However, the particles may also have other shapes, for example a platelet shape or a needle shape.

Examples of suitable amino resin based polymers are guanidine based polymers, melamine based polymers, urethane based polymers, amide based polymers, and urea based polymers, in particular methyl urea based polymers. The amino resin based polymer suitably is crosslinked, i.e. the polymer is a duroplast. Crosslinking can occur in the condensation reaction of the amino resin with formaldehyde. However, crosslinking can also be caused by additional crosslinking agents. Suitable solid particles of amino resin based polymer are commercially available, for example under the trade designation Deuteron® MK ex Deuteron GmbH, Germany. The Deuteron® MK particles are based on methyl urea polymer.

The major part of the volatile content of the coating composition consists of water. However, the coating composition can contain one or more organic solvents, with the proviso that the volatile organic content (VOC) of the ready-for-use coating composition does not exceed 420 g/l. Preferably, it does not exceed 210 g/l. The presence of such organic solvent can facilitate coalescence of the dispersed polymer particles to form a homogeneous film. Therefore, such solvents are frequently referred to as coalescing agents. As suitable coalescing agents may be mentioned dimethyl dipropylene glycol, methyl ether of diacetone alcohol, ethyl acetate, butyl acetate, ethyl glycol acetate, butyl glycol acetate, 1-methoxy-2-propyl acetate, butyl propionate, ethoxy ethyl propionate, toluene, xylene, methylethyl ketone, methyl isobutyl ketone, methyl isoamyl ketone, ethyl amyl ketone, dioxolane, N-methyl-2-pyrrolidone, dimethyl carbonate, 2,2,4-trimethyl-1,3-pentanediol monoisobutyrate, propylene carbonate, butyrolactone, caprolactone, and mixtures thereof.

To achieve a desired colour, the coating composition may contain one or more pigments. The pigments can be either organic or inorganic. The pigment content generally is in the range of 1 to 20% by weight, calculated on the weight of the film-forming polymer. Alternatively or additionally, the coating composition can contain one or more dyes which are wholly or partially soluble in the composition.

The coating composition can be applied to the flexible carrier substrate by known methods. Examples of such application methods are spreading (e.g., brushing, rolling, by paint pad or doctor blade), spraying (e.g., airfed spraying, airless spraying, hot spraying, and electrostatic spraying), and flow coating (e.g., dipping, curtain coating, roller coating, and reverse roller coating).

Drying of the applied coating layer can occur between 0 and 160° C., or between 5 and 80° C., or between 10 and 60° C., for example at ambient temperature. Drying at elevated temperature can be carried out in an oven. Alternatively, drying can be supported by infrared and/or near infrared radiation or by forced air movement. The dried coating generally has a layer thickness in the range of 30 μm to 400 μm, preferably the layer thickness is at least 80 μm and at most 300 μm.

The flexible carrier substrate may be provided in the form of a film wound on a reel. In that case, the substrate is de-reeled prior to application of the coating layer and re-reeled after the coating layer has dried. The resulting laminate may be shipped to potential customers or users in reeled from.

In a further embodiment, a backing layer is applied over the applied coating layer. The materials of backing layers normally used for this purpose include paper, e.g. crepe, flatback, tissue, and polymer films, e.g. polyester, polyvinyl chloride, polypropylene, polyethylene, fluoropolymers, cellulose acetate, and polyurethane. The backing layer may suitably be coated with a release agent to provide easy removal of the backing layer prior to transfer of the coating from the flexible carrier substrate to a second substrate. The release agents are typically based on binders containing silicone, a substance pressure-sensitive adhesives do not readily bond with. Acrylic emulsion release agents are an example of non-silicone based release agents.

The backing layer can serve as a temporary protection, e.g. against dust, of the applied coating layer during transport and storage of the laminate. The backing layer is removed prior to transfer of the coating from the flexible carrier substrate to a second substrate.

The backing layer can be applied contiguous with the coating layer. Alternatively, an adhesive layer may be applied between the coating layer and the backing layer. The adhesive layer can support adhesion of the temporary protective coating to the substrate. In one embodiment, the adhesive is a pressure-sensitive adhesive. Alternatively, the adhesive may be activatable thermally or by actinic radiation.

In step b) of the process the coating is transferred from the flexible carrier substrate to a second substrate to provide the second substrate with a temporary protective coating. In one embodiment, the flexible carrier substrate and the coating layer are first separated to generate a free coating layer, and subsequently the coating layer is contacted with the second substrate. If required, pressure can be applied to the coating layer to achieve adhesion between the coating layer and the surface of the second substrate. Suitably, the surface of the coating layer which has been in contact with the surface of the flexible carrier substrate is brought into contact with the surface of the second substrate. In one embodiment, a part of the coating layer is removed from the edge of the flexible carrier substrate, for example by manual peeling, and the surface of the coating layer is pressed against the second substrate. Subsequently, further parts of the coating are removed from the flexible carrier substrate, while simultaneously pressing further parts of the coating layer against the surface of the second substrate, until the coating layer is completely transferred from the flexible carrier substrate to the second substrate.

In embodiments wherein the adhesion between the flexible carrier substrate and the coating layer is lower than the adhesion between the coating layer and the second substrate, an alternative procedure may be followed. In this case, the transfer can also be achieved by contacting the surfaces of the second substrate and the laminate, with the coating layer facing the second substrate. Subsequently, pressure is applied to the flexible carrier substrate. This causes the coating layer to be transferred from the flexible carrier substrate to the second substrate and provides the second substrate with a temporary protective coating.

When the need for temporary protection and/or decoration of the second substrate no longer exists, the temporary coating layer can be removed by manually peeling the coating layer off the second substrate. It has been found that peeling of the coating layer can be carried out under a particularly broad variety of conditions, for example in a temperature range between 10° C. and 40° C. and at a relatively humidity of 15 to 90%. It has also been found that the process is suitable for longer term temporary protection. Even after 15 months of outdoor weathering the applied films offered good protection and could be removed from the substrate by peeling. This makes the process of temporary protection particularly robust and reliable.

The substrate suitably is a non-porous substrate. Examples of suitable non-porous substrates are metals which may have been pre-treated or not, pre-treated wood, synthetic polymeric materials, and glass. Further suitable substrates are other coats of paint, such as are present on transportation vehicles and motor vehicles or parts thereof, e.g., passenger cars, bicycles, trains, trucks, buses, boats, and airplanes.

The invention also provides a laminate which is very suitable for carrying out the process of the invention. The laminate comprises
a) a flexible carrier substrate and
b) a coating layer prepared by applying by spreading, spraying or flow coating an aqueous coating composition comprising at least one water based film-forming polymer and solid particles of an amino resin based polymer, and drying the applied coating composition.

Suitably, the coating is applied directly on the flexible carrier substrate, i.e. the coating layer is contiguous with the flexible carrier substrate. In a further embodiment, a removable backing layer is applied directly on the coating layer. This means that the backing layer is contiguous with the coating layer.

### EXAMPLE

An aqueous coating composition was prepared by mixing the following components:

| | Parts by |
|---|---|
| Component | weight |
| Emultex ® AC 430, Aqueous dispersion of a vinyl acetate-butyl | 36.94 |
| acrylate copolymer ex Synthomer | |
| Revacryl ® 274, Aqueous dispersion of an acrylic ester- | 45.15 |
| acrylonitrile copolymer ex Synthomer | |
| Commercially available toner composition comprising | 12.98 |
| pigments | |
| Texanol ® (2,2,4-trimethyl-1,3-pentanediol monoisobutyrate) | 2.46 |
| Deuteron ® MK, Amino resin based polymer particles ex | 2.46 |
| Deuteron | |

A laminate was prepared by spray applying the coating composition to the siliconized surface of Avery® DOL 4000 vinyl foil. This foil is available from Avery Dennsion Graphics Division. The wet layer thickness of the applied coating was in the range of 250 to 300 μm. The coating was allowed to dry 30 minutes at room temperature, followed by a 60 minutes drying cycle in an oven at 60° C. Thereafter, the laminate was allowed to cool to room temperature. Alternatively, the applied coating can be dried for 12 hours at room temperature to form the laminate.

A second siliconized foil was placed on the coated surface of the laminate and the laminate was coiled up.

Before transfer of the coating layer the coil was unwound and the second siliconized foil was removed. Then a part of the coating layer was removed from the edge of the Avery® DOL 4000 vinyl foil by manual peeling, and the surface of the coating layer which had been in contact with the Avery® DOL 4000 vinyl foil was pressed against the surface of a metal panel coated with an automobile multilayer paint. Subsequently, further parts of the coating layer were removed from the Avery® DOL 4000 vinyl foil while simultaneously further parts of the coating layer were pressed against the surface of the coated metal panel, until the coating layer was completely transferred from the Avery® DOL 4000 vinyl foil to the metal panel, thus providing a temporary protective coating on the metal panel. The temporary protective coating could be removed by manual peeling without rupture of the temporary protective coating layer.

1. A process of applying a temporary protective coating to a substrate comprising the steps of:
a) providing a laminate comprising
i) a flexible carrier substrate and
ii) a coating layer prepared by applying by spreading, spraying or flow coating an aqueous coating composition comprising at least one water based film-forming polymer and solid particles of an amino resin based polymer to the flexible carrier substrate, and drying the applied coating composition, and
iii) a backing layer applied over the applied coating layer
b) removing the backing layer, and
c) transferring the coating layer from the flexible carrier substrate to a second substrate to provide the second substrate with a temporary protective coating, wherein there is no adhesive layer between the second substrate and the temporary protective coating.

2. The process according to claim 1, wherein the amino resin based polymer is a methyl urea based polymer.

3. The process according to claim 1, wherein the aqueous coating composition comprises 1 to 25% by weight, based on the weight of the total composition, of solid particles of an amino resin based polymer.

4. The process according to claim 1, wherein the aqueous coating composition further comprises a coalescing agent.

5. The process according to claim 1, wherein the flexible carrier substrate is a foil based on an organic polymer.

6. The process according to claim 1, wherein in step b) the flexible carrier substrate and the coating layer are first separated to generate a free coating layer, and subsequently the coating layer is contacted with the second substrate.

7. The process according to claim 1, further comprising the additional step d) of removing the temporary protective coating from the second substrate by peeling.

8. The process according to claim 1, wherein the second substrate is an automobile or transportation vehicle.

9. A laminate comprising
a) a flexible carrier substrate and
b) a coating layer prepared by applying by spreading, spraying or flow coating an aqueous coating composition comprising at least one water based film-forming polymer and solid particles of an amino resin based polymer to the flexible carrier substrate, and drying the applied coating composition, wherein the coating layer is contiguous with the flexible carrier substrate, and
c) a removable backing layer which is contiguous with the coating layer.

10. The laminate according to claim 9, wherein the flexible carrier substrate is a foil based on an organic polymer.

11. The process according to claim 2, wherein the aqueous coating composition comprises 1 to 25% by weight, based on the weight of the total composition, of solid particles of an amino resin based polymer.

12. The process according to claim 2, wherein the aqueous coating composition further comprises a coalescing agent.

13. The process according to claim 2, wherein the flexible carrier substrate is a foil based on an organic polymer.

14. The process according to claim 4, wherein the flexible carrier substrate is a foil based on an organic polymer.

15. The process according to claim 4, wherein in step b) the flexible carrier substrate and the coating layer are first separated to generate a free coating layer, and subsequently the coating layer is contacted with the second substrate.

16. The process according to claim 5, wherein in step b) the flexible carrier substrate and the coating layer are first separated to generate a free coating layer, and subsequently the coating layer is contacted with the second substrate.

17. The process according to claim 5, further comprising the additional step d) of removing the temporary protective coating from the second substrate by peeling.

18. The process according to claim 6, further comprising the additional step d) of removing the temporary protective coating from the second substrate by peeling.

19. The process according to claim 6, wherein the second substrate is an automobile or transportation vehicle.

20. The process according to claim 7, wherein the second substrate is an automobile or transportation vehicle.
